(19) United States
(12) Patent Application Publication
(10) Pub. No.: US 2010/0228792 A1
(43) Pub. Date: Sep. 9, 2010

(54) System for Conducting Persistent Periodic Common Weighted Background Investigations

(76) Inventor: Anthony Gray, Tampa, FL (US)

Correspondence Address: ContinuCheck LLC;Attention: Anthony Gray, 3019 West Azeele St., Tampa, FL, 33609, US

(21) Appl. No.: 12/393,022

(22) Filed: Feb. 25, 2009

(51) Int. Cl. G06F 17/30; G06F 7/00

(52) U.S. Cl. 707/804; 707/E17.044; 707/E17.005; 707/E17.108

(57) ABSTRACT

A system for conducting persistent common weighted personnel background investigations. An investigator enters the subject's known applicable information that includes the subject's name, address, social security number, date of birth into the system. Once entered into the system, a report on background investigation findings is automatically generated and provided to the investigator. The report also contains a risk score and rating for the subject based on a common weighted set of evaluation criteria. Periodically afterward, a report of any new background investigation findings is automatically provided to the investigator along with the updated risk score. Reports continue to be generated periodically until the subject's name is removed from the system.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The subject invention is generally related to background investigations and specifically the invention relates to a system that automatically generates common weighted factors and automatically reports updates on the subject's background on a persistent periodic basis.

2. Discussion of the Prior Art

A background “investigation” or “check” is an inquiry into an individual's character, general reputation, personal characteristics, and/or mode of living. Background investigations are conducted for a multitude of reasons by individuals or organizations seeking to protect their interests prior to engaging with another individual. For example, a company will conduct a background investigation on a prospective employee. Individuals and organizations conduct background investigations for increasing productivity and retention, mitigating risk to their reputation, mitigating the risk of “negligent hiring” and “negligent retention” lawsuits, providing a safe environment for other employees and volunteers, reducing the risk of theft or other illicit activity, or in some cases, background investigations are required by law for some employment.

The prior art means of handling these background investigations is as a one-time event typically prior to engaging the subject such as during the pre-employment hiring process. In addition, background investigation report findings present the raw data typically without any synopsis of the relative significance of the findings. If a synopsis is provided, it is either based on a subjective professional opinion of an analyst or on a set of variably weighted factors identified by the investigator. The prior art lacks a means of persistently conducting periodic background checks with findings reported in a common weighted format.

An individual's background activities are just as important, if not more important, post-engagement as they are pre-engagement. For example, court proceedings, criminal activity, and weapons purchases conducted after hiring, all may be leading indicators of an employee with an increased risk to the organization and other employees. Unless persistent periodic background investigations are conducted, such activity would likely go undetected thus exposing the organization to increased unknown risks and liability. Furthermore, if there is no consistent means of representing the results of investigations on a common set of weighted factors, it is difficult to perceive changes in an individual's background and the significance of such findings. A system for conducting persistent periodic common weighted background investigations is needed.

### SUMMARY OF THE INVENTION

Embodiments of the invention provide the system that allows for an account to be opened by an individual or organization. The lead point of contact for the account, has the ability to manage the account by giving other individuals system access, viewing, and account management privileges.

In a further embodiment of the invention a system for entering a subject's name and their pertinent information including at least one data element from the group of data elements that includes name, date of birth, residential address, and social security number, an initial report of findings in the form of raw data and a score and rating of the individual's risk based on a set of common weighted criteria. Persistent periodic reports continue to be generated until the individual's name is removed from the system.

### BRIEF DESCRIPTION OF THE SEVERAL VIEWS OF THE DRAWING

FIG. 1 is a block diagram of a background investigation system that provides automated reports via an internet computer network on a persistent periodic basis.

FIG. 2 is a flowchart of the account management process

FIG. 3 is a flowchart of the reporting, risk scoring, and rating process

### DETAILED DESCRIPTION OF THE INVENTION

The invention consists of a system allowing investigators to obtain background information on subjects on a persistent periodic basis with results presented in the context of common weighted criteria. This allows the investigator to stay abreast of the subject's background activities in near real time with the automatic recurring reports containing personnel background data, a common weighted criteria risk score, and risk rating.

The background check can contain information from county court databases, federal court databases, federal criminal databases, state weapons purchase databases, state driving record databases, state sex offender databases, local and state criminal and prison databases, and any other public or private records database of interest. The raw data of findings is presented to the investigator along with the subject's risk score. The risk score concept is much like the credit reporting industry Fair Isaac Corporation (FICO) Score where financial lenders are able to investigate and quickly assess a subject's credit worthiness. Therefore, the raw data is processed by the risk score algorithms employing common weighted criteria that produce a risk score for the subject. Like the FICO Score, the investigator is now able to quickly identify the riskiness of the subject. In order to make the scoring concept even more intuitive, a risk rating algorithm also generates a relative rating of Low, Medium, High risk that shows how the score rates the subject on a relative basis. Thus, the investigator is quickly able to see the exact score, how relatively risky that score is, and the supporting raw data.

The score and rating algorithms can also be aggregated to show the average risk score and rating for their organization. This allows the investigator to quickly interpret worsening or improving trends on both individual subjects and whole organizations or groups of subjects. This allows the investigator to take action to mitigate their risk to negligent retention lawsuits, improve employee safety, improve operational efficiencies, reduce operating losses, and enhance morale. In some situations, it is understandable that an investigator may need professional security or legal counsel to advise them on the best way to proceed with a candidate exhibiting a concerning background behavior. The invention offers the ability for the investigator to quickly notify third party providers capable of providing a rapid response to their query. For example, a human resource manager may find an employee has rapidly increased their risk score and rating with questionable background activity that may lead to the harm of other employees. The system allows the human resource manager to automatically notify a private security company for support. The private security company third party conducts a consultation with the investigator human resource manager and can advise them on ways to mitigate the risk and or provide the security services to mitigate the risk. In addition, this function also can allow the human resource manager to automatically notify a third party human resource legal team able to advise and support the human resource manager on ways to mitigate liability.

In addition, the system enhances the hiring process with the ability for investigators to enter an unlimited number of candidates into the system at no cost. This encourages the investigators to employ the system for pre-employment screening with a no cost offer. Any names removed from the system before the first periodic report is issued (typically at the one month point) is billed. Thus, investigators can freely enter subjects, conduct an initial no cost background check, and then remove a subject from the system before the first periodic report, with no financial consequence.

System Architecture

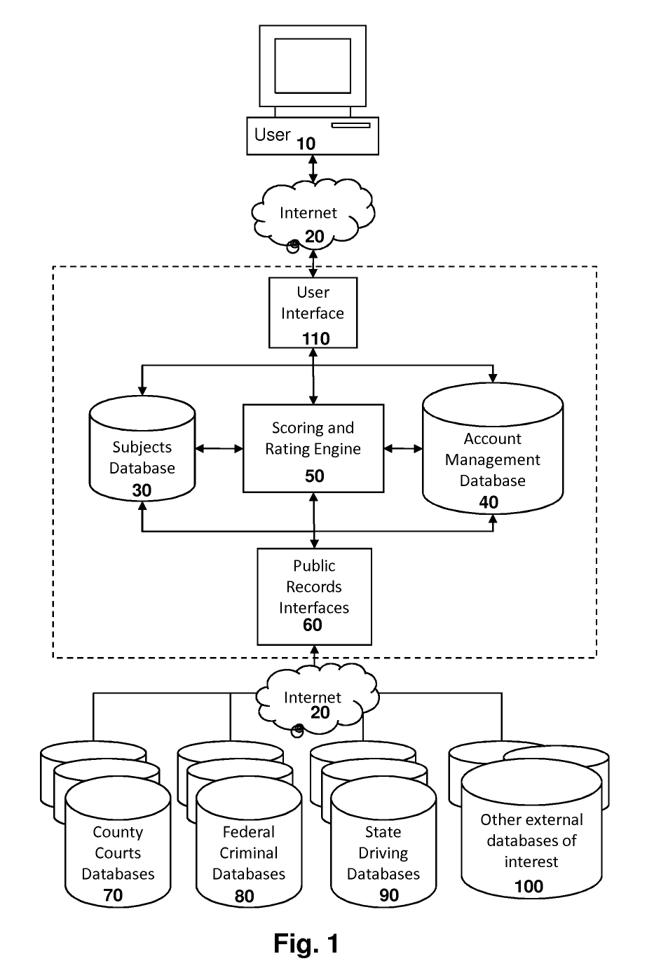

FIG. 1 is a block diagram of a background check system that automatically provides persistent common weighted background information to investigators configured in accordance with one embodiment of the present invention.

The investigator can log into the system via device 10. The device 10 can be any form of internet computer network connection. The internet 20 can consist of wire connections via telephone or cable wiring and an appropriate wiring with modem or via wireless connections. The User Interface 110 presents all of the information and functionality to the user. The Subjects Database 30 contains the subject data that includes at least one element of data from the group of data that includes home address, full name, date of birth, address, social security number. along with historical records of subject background checks and reports. The Account Management Database 40 contains the contact information details for the investigators and their organization along with account management settings. The Scoring and Rating Engine 50 processes the background check queries and calculates scoring and rating algorithms on information gathered from the public records received via the Public Records Interfaces 60 that are connected to the external public records databases via the internet 20. The County Courts Databases 70, the Federal Criminal Databases 80, and the State Driving Databases 90, all represent the likely sources of public records background check data along with any other external databases of interest 100.

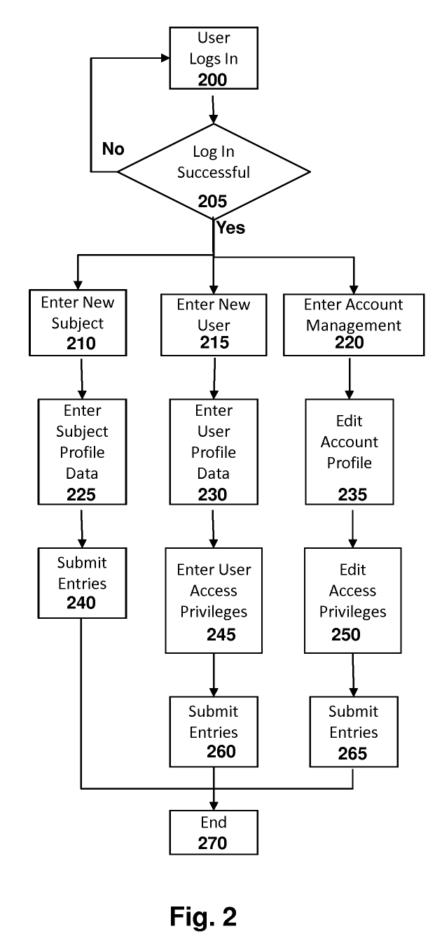

FIG. 2 is a process flowchart diagram of the new subject entry, new user entry, and account management processes. A user logs into the system 200 and with a successful log in 205, they can access the subject entry, new user entry, and account management functions. When the user would like to conduct background investigations on a new subject, they select the Enter New Subject function 210 and enter the subject profile information 225 that includes at least one element of data from the group of data that includes, full name, home address, social security number, date of birth and submits the data for processing 240. When the user would like to add a new user to the system, they select the Enter New User function 215. The new user's profile data that includes at least one element of data from the group of data that includes, full name, title, phone number, address, date of birth, are entered. 230. The new user is then granted various access privileges 245 to view records, view certain groups of records, enter new subjects, enter new users, or have master account management privileges. Once the new user profile and access privileges are entered, the entries are submitted 260. The Enter Account Management 220 function allows the user to edit the overall account profile. The user can edit the account profile information 235 that includes at least one element of data from the group of data that includes, company address, point of contact name, title, phone number and edit access privileges 250 of the users. Once the changes are made, they are submitted 265. Upon completion of the above activities, the process ends 270.

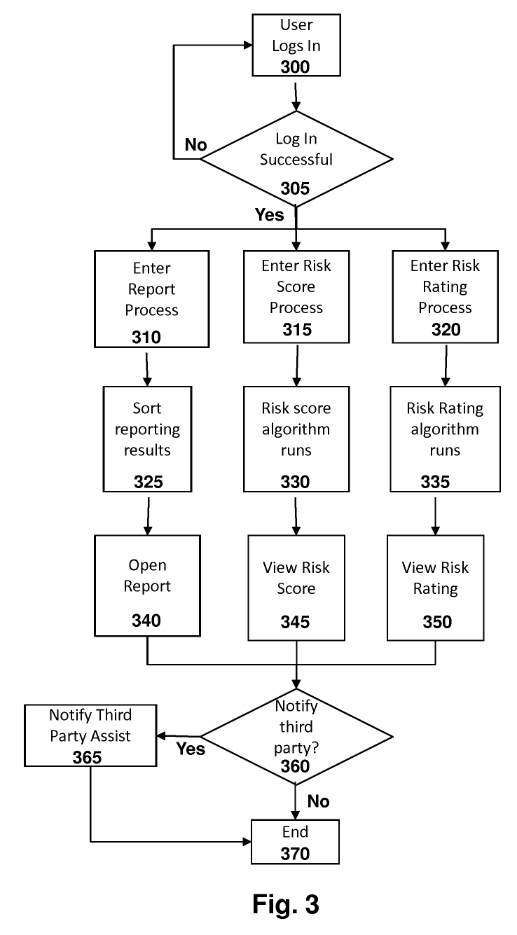

FIG. 3 is a process flowchart diagram of the reporting, risk scoring, and risk rating processes. A user logs into the system 300 and with a successful log in 305, they can access the reporting, risk scoring, and risk rating functions of the system. When the user would like to receive a background investigation report on a subject or subjects, they can enter the report process 310. The system recognizes the user's access privileges and presents a list of reports on individuals within their organization 325. Each list line item shows the subject's name, risk score, and risk rating where the list automatically shows with higher levels of risk at the top of the list, however, the list can be sorted by name, organization, risk score, risk rating, or other variables. The user may also conduct a search on a specific name to pull up an individual report. This function also allows the user to receive the periodic reports to their email on a recurring basis. This reporting function may also be configured to alert the investigator whenever a new piece of background investigation data is discovered, or when the subject's risk score and rating change. When the investigator enters the Risk Score process 315, they are able to run the Risk Score Algorithm 330 and view the results of the risk score 345. The risk score algorithms assign weighted values to each component of public record data collected. The algorithm also accounts for the duration since the background check data originated and the compounded effect when combined with the other pieces of background check data. For example a subject with a speeding ticket that took place five years ago would receive a much lower risk score than a subject with recent Driving Under the Influence, a recent weapons purchase, and an arrest for public disorderly conduct because of the latter subject had more data points of greater severity and the combination of all three data points indicate an individual with a very high risk ratio. The algorithm weighted values and compound multiples are common for every subject so that investigators may easily identify which subjects are a greater risk than others. The risk score algorithm is also able to calculate the average risk ratio for an organization and any sub groups within that organization. For example, a company human resource manager can view the risk score for the entire company or view the risk score for individual departments.

We claim:

1. A system for conducting persistent common weighted background investigations, the system comprising:
a user interface to receive initial subject data from an investigator, that initiates automated background investigation results on a periodic recurring basis; and
a public records interface configured to receive data from multiple public records data sources.

2. A system of claim 1, wherein the subject is the focal point of the background investigation.

3. A system of claim 1, wherein the investigator is the initiator, recipient, and user of the background investigation information.

4. A system of claim 1, wherein the user interface is accessed via a computer connected to the system via a computer network connection.

5. The system of claim 1, further comprising a subject database with subject initial data and an archive of previous subject periodic reports.

6. The system of claim 1, further comprising a scoring and rating engine.

7. The system of claim 6, further comprising of an automated algorithm that generates individual subject risk scores based on weighted factors associated with the database search results.

8. The system of claim 6, further comprising of an automated algorithm that generates individual subject risk ratings based on a comparative basis in relation to common threshold values.

9. The system of claim 6, further comprising an automated algorithm that generates an aggregate risk score for a group of subjects.

10. The system of claim 6, further comprising an automated algorithm that generates an aggregate risk rating for a group of subjects.

11. A system of claim 6, wherein initial and periodic reports are transmitted to the investigator.

12. The system of claim 1, further comprising an account management database.

13. A system of claim 12, wherein the account manager can update account profile information.

14. A system of claim 12, wherein the account manager can control user access privileges to the system.

15. The system of claim 12, further comprising a report viewer wherein the investigator can view subject background check results for all subjects they have access to view in one complete report.

16. A system of claim 15, wherein the investigator can sort fields of the report by name, work location, risk score, risk rating, or other rating criteria.

17. A system of claim 15, wherein the investigator can search individual current and archived subject reports and group reports by searching on name, group name, and other key word search criteria.

18. A system of claim 1, wherein the public records or other databases of interest are accessed via the internet.

19. The system of claim 1, further comprising a third party notification system.

20. A system of claim 19, wherein the third party is notified via email, text message, and automated voice communication notifications.

21. A system of claim 19, wherein the third party consists of a security company, legal firm, and other third parties prepared to provide consultative guidance to an investigator.

22. A system of claim 19, wherein the third party receives a copy of the subject report of which the investigator seeks further support from the third party.

23. A system of claim 12, wherein an authorized investigator can add and remove subjects from the system.

24. A system of claim 12, wherein any subject remaining in the system at the time of the first periodic report initiates a billing for services to the investigator.
